(19) United States
(12) Patent Application Publication
(10) Pub. No.: US 2012/0256445 A1
(43) Pub. Date: Oct. 11, 2012

(54) VEHICLE ROOF SUPPORT PILLAR

(76) Inventors: Ridha Baccouche, Ann Arbor, MI (US); Saied Nusier, Canton, MI (US); David Anthony Wagner, Northville, MI (US); Xiaowei Li, Northville, MI (US); Duncan Whipps, Grosse Pointe Farms, MI (US)

(21) Appl. No.: 13/080,636

(22) Filed: Apr. 5, 2011

(51) Int. Cl. B62D 25/04

(52) U.S. Cl. 296/193.06; 296/193.05; 296/203.03

(57) ABSTRACT

The vehicle roof support pillar is provided which includes a pillar inner panel, a pillar outer panel and a unitary closed-section reinforcement member. The unitary closed-section reinforcement member is disposed entirely within a chamber defined by the pillar inner panel and the pillar outer panel. The unitary closed-section reinforcement member includes an upper area and a lower area. The lower area of the unitary close-section reinforcement member has an increasing cross-section below the buckling line. The pillar inner panel includes upper and lower ends. The lower inner end has a greater width relative to the upper inner end. The pillar outer panel also has a progressively increasing width relative to the upper outer end.

### BACKGROUND

The present disclosure generally relates to vehicle structures, and more particularly to a high strength and low weight roof support pillar for a vehicle.

It is well known that in order to improve fuel efficiency and vehicle emissions, it is desirable to produce a lightweight motor vehicle. To achieve this goal, several vehicle manufacturers have proposed vehicles in which a substantial proportion of the body structure or body shell is constructed from a lightweight material such as an aluminum alloy. An example of such a vehicle construction is shown in U.S. Pat. No. 6,099,071.

With reference to FIG. 1, a body structure of motor vehicles is generally composed of longitudinal beams 102, cross beams 104 and columns beams 106 where such beams are traditionally formed from two stamped members (inner panel 112 and outer panel 114) which create a closed cross-section as shown in FIG. 2. The two connected metal half-shells typically form the various components of a body structure.

Reinforcements between the inner and outer sheet metal structures are generally not employed. However, to the extent reinforcement members are employed, the reinforcement members for vehicle body structures are generally provided to improve the vehicle structure's performance in a side impact collision or a rear end collision.

For example, DE 3103580 A1 and U.S. Pat. No. 4,462,633 improve occupant protection in the event of a side impact collision. The vehicle body structure components are aligned with the rocker such that the rocker provides structure, stiffness and strength to protect the vehicle occupant in a side impact collision. Similarly, in EP0037587 A1, the reinforcement for the vehicle body structure components is operatively configured to protect a passenger in the event of a collision also comes in the form of partition plates at vehicle rocker.

Other support structures are shown, for example, in U.S. Pat. No. 5,267,772. U.S. Pat. No. 5,267,772 discloses a reinforcement which is formed in the quarter panel by placing a closed cross-sectional channel against the inner wall of the quarter panel. This channel extends between the rear fender panel and the quarter panel along the length of the rear body portion. The reinforcement is controlled by a crush pattern control means so that the reinforcement causes an intended pattern of deformation of the rear body portion in the event of a rear-end collision. The impact energy of a rear-end collision applied to the vehicle is absorbed during the deformation of this reinforcement.

Finally, DE19528874 A1 discloses a body structure for a motor vehicle where a reinforcement structure is also provided within a two piece hollow body structure component. However, this multi-part profile arrangement is quite complicated and run produced only with considerable manufacturing and assembly costs.

Accordingly, it is desirable to implement a low cost, robust, light weight and high strength pillar structure which can improve the roof strength of a vehicle.

### SUMMARY

A vehicle roof support pillar is disclosed according to the embodiment(s) provided herein. The vehicle roof support pillar includes a pillar inner panel, a pillar outer panel and a unitary closed-section reinforcement member. The unitary closed-section reinforcement member is disposed entirely within a chamber defined by the pillar inner panel and the pillar outer panel. The unitary closed-section reinforcement member includes an upper area and a lower area. The lower area of the unitary close-section reinforcement member has an increasing cross-section below the buckling line. The pillar inner panel includes upper and lower ends. The lower inner end has a greater width relative to the upper inner end. The pillar outer panel also has a progressively increasing width relative to the upper outer end.

### BRIEF DESCRIPTION OF THE DRAWINGS

The present invention will now be described by way of example, with reference to the accompanying drawings:

FIG. 1 is a partial isometric view of a body structure of a vehicle.

FIG. 2 is an expanded side view of a traditional b-pillar of a vehicle.

FIG. 3A is an expanded side view of an embodiment of the present disclosure.

FIG. 3B is an expanded side view of another embodiment of the present disclosure.

FIG. 4A is a cross-sectional view of the embodiment of the present disclosure along lines A-A in FIG. 3B.

FIG. 4B is a cross-sectional view of the embodiment of the present disclosure along lines B-B in FIG. 3B.

FIG. 4C is a cross-sectional view of the embodiment of the present disclosure along lines C-C in FIG. 3B.

FIG. 5A is a cross sectional view of yet another embodiment of the present disclosure.

FIG. 5B is a cross-sectional view of another embodiment of the present disclosure.

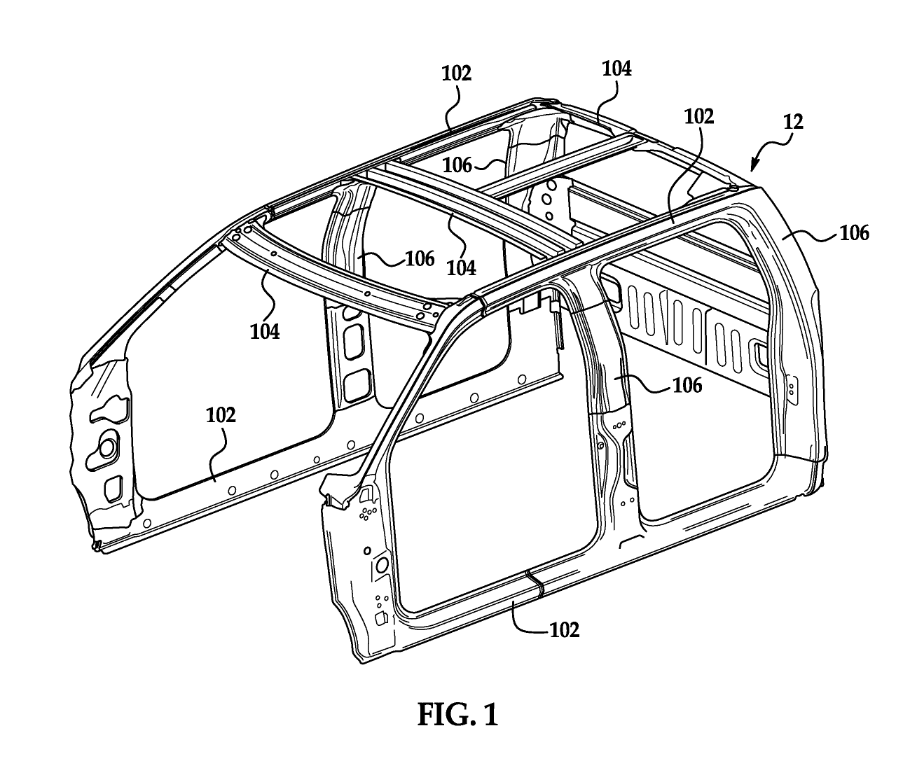

### DETAILED DESCRIPTION

Referring now to the drawings wherein like reference numerals are used to identify identical components in the various views.

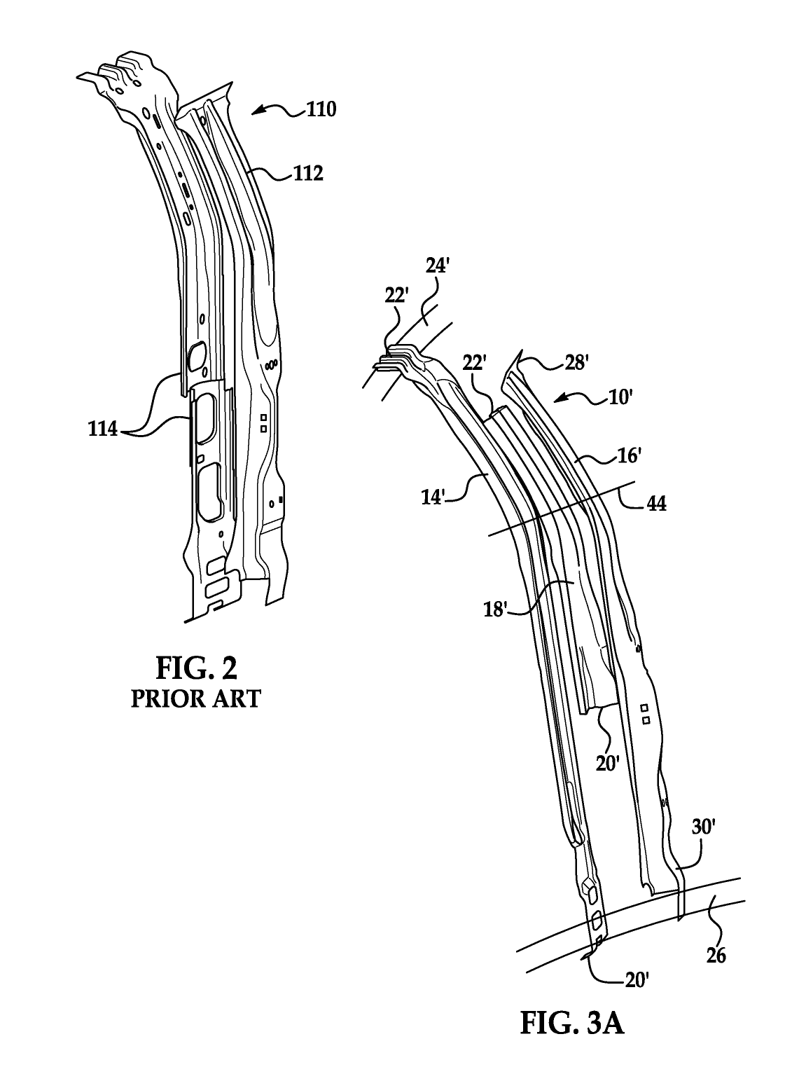

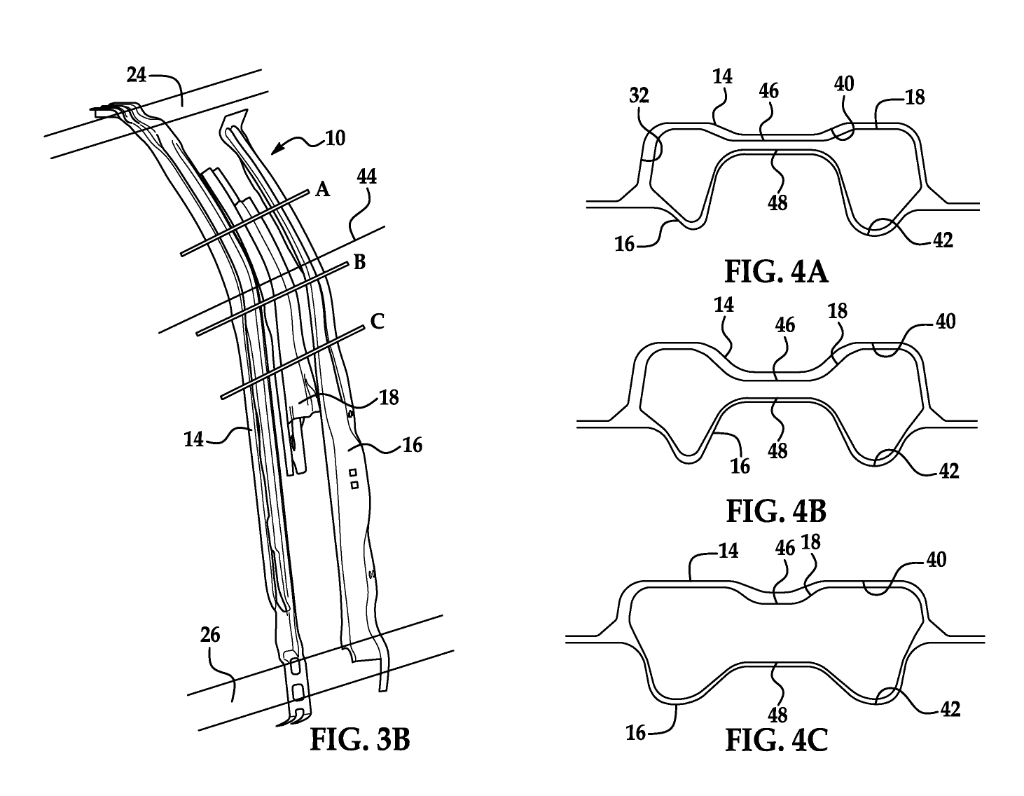

With reference to FIG. 3B, a partial expanded view of the present disclosure is shown. The vehicle roof support pillar 10 includes a pillar inner panel 14, a pillar outer panel 16 and a unitary closed-section reinforcement member 18. The pillar inner panel 14 includes an upper inner end 22 and a lower inner end 20.

The upper inner end 22 of the pillar inner panel 14 is proximate to the roof rail 24 of the vehicle. The lower inner end 20 of the pillar inner panel 14 is proximate to the rocker 26 of the vehicle. The lower inner end 20 has width that is greater than the upper inner end 22. Accordingly, as the pillar inner panel 14 extends toward the rocker 26, the width of the pillar inner panel 14 increases.

A pillar outer panel 16 is affixed to the pillar inner panel 14 via a welding process, mechanical fasteners or the like. The pillar outer panel 16 also includes an upper outer end 28 and a lower outer end 30 wherein the upper outer end 28 is proximate to the roof rail 24. The lower outer end 30 of the pillar outer panel 16 is proximate to the rocker 26. The pillar outer panel 16 also has a progressively increasing width relative to the upper outer end 28. As the pillar outer panel 16 extends toward the rocker 26, the width of the pillar outer panel 16 increases or widens as shown in FIGS. 4A-4C.

The unitary closed-section reinforcement member 18 is disposed entirely within a chamber defined by the pillar inner panel 14 and the pillar outer panel. The unitary closed-section reinforcement member 18 includes an upper area 36 and a lower area 38. The lower area 38 of the unitary closed-section reinforcement member 18 (or alternatively referenced as “reinforcement member”) is progressively increasing in cross section relative to the upper area 36 of the unitary closed-section reinforcement 18. Accordingly, as the reinforcement member 18 extends below the buckling line, the cross-sectional area of the unitary closed-section reinforcement member 18 increases.

It is also to be understood that the unitary closed-section reinforcement member 18 has a varying cross section. As shown in FIGS. 4A-4C, the unitary closed section reinforcement member 18 is generally co-extensive with the interior surface 42 of the pillar outer panel 16 and the interior surface 40 of the pillar inner panel 14. The cross section at or above the buckling line 44 may increase or decrease. Nonetheless, it is to be understood that the cross-section generally increases as the unitary closed-section reinforcement member 18 extends below the buckling line 44.

The closed-section reinforcement member 18 is disposed both below and above the buckling line on the inner side of the B-Pillar 58?. The closed-section reinforcement member 18 attaches to a one-piece B-Pillar inner and to the one-piece B-pillar outer in several locations around the beltline over a length extending for several inches both below and above the buckling line 44 location. The closed-section reinforcement member 18 provides self-stability through its closed and multi-shaped cross section that attaches to the same buckling inner B-pillar. By attaching the unitary closed-section reinforcement member to the pillar inner panel, the roof strength of the vehicle is improved given that there is a higher thickness to the (buckling plate) width ratio.

This thickness to width (t/w) ratio allows for higher critical stresses thus higher buckling stresses. Thus, higher buckling stresses may be applied to the roof of a vehicle structure. Accordingly, the material use is optimized. For example, the present disclosure allows for a two-thickness level flanges (instead of three or four thickness) thereby providing a lighter weight structure. Moreover, the unitary structure of the closed section reinforcement member 18 provides improved stiffness in the roof pillar area of the vehicle without adding unnecessary weight or requiring a costly manufacturing/assembly process. Furthermore, this structural stability is achieved through connecting both the pillar inner panel 14 and the pillar outer panel in and around the buckling line 44.

Accordingly, the unitary closed-section reinforcement member 18 is operatively configured to connect the pillar inner panel 14 to the pillar outer panel 16 in the event of a roof impact to the vehicle to deter buckling in the roof support pillars 10. As shown in FIGS. 4A-4C, the unitary closed-section reinforcement member 18 includes an inner face 46 and an outer face 48 directly opposite the inner face 46. The inner face 46 is adjacent to the pillar inner panel 14 and the outer face 48 is adjacent to the pillar outer panel 16.

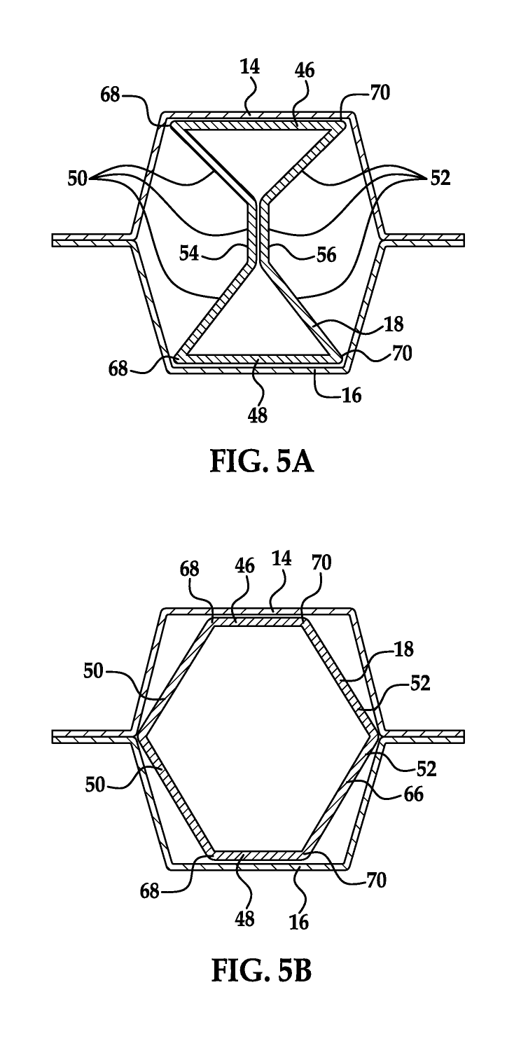

Referring now to FIG. 5B, another non-limiting example of the unitary closed section reinforcement member 18 is illustrated. A cross-sectional of the reinforcement member 18 is shown where the reinforcement member 18 has a cross-sectional shape in the form of a hexagon.

The unitary closed-section reinforcement member 18 further comprises a front face 50 and a rear face 52. The front face 50 connects the inner face 46 to the outer face 48 at a front end 68 of each of the inner face 46 and the outer face 48. The rear face 52 connects the inner face 46 to the outer face 48 at a rear end 70 of the front face 50 and the rear face 52. In yet another non-limiting example of the unitary closed-section reinforcement member 18, the middle portions 54, 56 of the front face 50 and the rear face 52 may be affixed to each other as shown in FIG. 5A.

With reference to FIG. 3A, in another embodiment of the present disclosure, a vehicle roof support pillar 10′ is provided wherein the roof support pillar 10′ includes a pillar inner panel 14′ having an upper inner end 22′ and a lower inner end 20′. The pillar inner panel 14′ increases in width as the pillar inner panel 14′ extends toward the rocker 26. A pillar outer panel 16 is affixed to the pillar inner panel 14. The pillar outer panel 16′ has an upper outer end 28′ and a lower outer end 30′. The lower outer end 30′ has a progressively increasing width relative to the upper outer end 28′.

The unitary closed-section reinforcement member 18′ is disposed entirely within a chamber defined by the pillar inner panel 14′ and the pillar outer panel 16′. The unitary closed-section reinforcement member 18′ has an upper end 22′ and a lower end 20′. The unitary closed-section reinforcement member 18′ has a varying cross-section between the upper end 22′ and the lower end 20′. The varying cross-section improves the vehicle stability by preventing buckling in the pillar inner panel 14 given that the reinforcement member 18′ and the pillar outer panel 16 are providing support to the pillar inner panel 14. Given the varying cross section of the unitary closed-section reinforcement member 18′, the unitary closed-section reinforcement member 18′ is stationary between the pillar inner panel 14′ and the pillar outer panel 16′, and therefore, prevents buckling in the pillar inner panel 14′ and the pillar outer panel 16′.

As indicated, the unitary closed-section reinforcement member 18′, 18 (shown in FIGS. 3A and 3B) may achieve a varying cross-section or an increasing cross section through different manufacturing processes. One manufacturing process that is well-suited for the present application is a hydroforming process. Unlike a roll-forming or extrusion process, the hydroforming process can produce a product that has a closed section and a varying cross section. In order to form the reinforcement member 18 using a hydroforming process, a hollow tube of aluminum may be placed inside a negative mold. High pressure hydraulic pistons may then inject a fluid at very high pressure inside the aluminum which causes it to expand until it matches the mold. The hydroformed reinforcement member 18, 18′ having a varying cross section or an increasing cross section may then removed from the mold.

Hydroforming allows complex shapes with concavities to be formed, which would be difficult or impossible with standard solid die stamping. Hydroformed parts can often be made with a higher stiffness to weight ratio and at a lower per unit cost than traditional stamped or stamped and welded parts. The hydroformed reinforcement member 18′, 18 may then be affixed between the pillar inner panel 14, 14′ and the pillar outer panel 16, 16′.

While the best mode for carrying out the invention has been described in detail, those familiar with the art to which this invention relates will recognize various alternative designs and embodiments for practicing the invention as defined by the following claims.

What is claimed is:

1. A vehicle roof support pillar comprising:
a pillar inner panel having an upper inner end and a lower inner end, the lower inner end having a progressively increasing width relative to the upper inner end;
a pillar outer panel affixed to the pillar inner panel, the pillar outer panel having an upper outer end and a lower outer end, the lower outer end having a progressively increasing width relative to the upper outer end; and
a unitary closed-section reinforcement member disposed entirely within a chamber defined by the pillar inner panel and the pillar outer panel, the unitary closed-section reinforcement member having an upper area and a lower area, the lower area of the unitary closed-section reinforcement member progressively increasing in cross section relative to the upper area of the unitary closed-section reinforcement member.

2. The vehicle roof support pillar as defined in claim 1 wherein the pillar inner panel is affixed to the pillar outer panel using a welding process.

3. The vehicle roof support pillar as defined in claim 1 further comprising a plurality of mechanical fasteners operatively configured to affix the pillar inner panel to the pillar outer panel.

4. The vehicle roof support pillar as defined in claim 1 wherein the unitary closed-section reinforcement member has a varying cross section.

5. The vehicle roof support pillar as defined in claim 1 wherein the unitary closed-section reinforcement member is operatively configured to connect the pillar inner panel to the pillar outer panel in the event of a roof impact to the vehicle.

6. The vehicle roof support pillar as defined in claim 1 wherein the unitary closed-section reinforcement member further comprises an inner face and an outer face directly opposite the inner face.

7. The vehicle roof support pillar as defined in claim 6 wherein the inner face is adjacent to the pillar inner panel and the outer face is adjacent to the pillar outer panel.

8. The vehicle roof support pillar as defined in claim 1 wherein the unitary closed section reinforcement member has a cross-sectional shape in the form of a hexagon.

9. The vehicle roof support pillar as defined in claim 7 wherein the unitary closed-section reinforcement member further comprises a front face and a rear face.

10. The vehicle roof support pillar as defined in claim 9 wherein the front face and the rear face are affixed each other.

11. A vehicle roof support pillar comprising:
a pillar inner panel having an upper inner end and a lower inner end, the lower inner end having a progressively increasing width relative to the upper inner end;
a pillar outer panel affixed to the pillar inner panel, the pillar outer panel having an upper outer end and a lower outer end, the lower outer end having a progressively increasing width relative to the upper outer end; and
a unitary closed-section reinforcement member disposed entirely within a chamber defined by the pillar inner panel and the pillar outer panel, the unitary closed-section reinforcement member having an upper end and a lower end, the unitary closed-section reinforcement member having a varying cross-section between the upper end and the lower end.

12. The vehicle roof support pillar as defined in claim 11 wherein the unitary closed-section reinforcement member is a hydroformed member.

13. The vehicle roof support pillar as defined in claim 11 wherein the pillar inner panel is affixed to the pillar outer panel using a welding process.

14. The vehicle roof support pillar as defined in claim 11 further comprising a plurality of mechanical fasteners operatively configured to affix the pillar inner panel to the pillar outer panel.

15. The vehicle roof support pillar as defined in claim 11 wherein the unitary closed-section reinforcement member is operatively configured to connect the pillar inner panel to the pillar outer panel in the event of a roof impact to the vehicle.

16. The vehicle roof support pillar as defined in claim 11 wherein the unitary closed-section reinforcement member further comprises an inner face and an outer face directly opposite the inner face.

17. The vehicle roof support pillar as defined in claim 16 wherein the inner face is adjacent to the pillar inner panel and the outer face is adjacent to the pillar outer panel.

18. The vehicle roof support pillar as defined in claim 11 wherein the unitary closed section reinforcement member has a cross-sectional shape in the form of a hexagon.

19. The vehicle roof support pillar as defined in claim 17 wherein the unitary closed-section reinforcement member further comprises a front face and a rear face, the front face connecting the inner face to the outer face at a front end of each of the inner face and the outer face; and the rear face connecting the inner face to the outer face at a rear end of the front face and the rear face

20. The vehicle roof support pillar as defined in claim 9 wherein the front face and the rear face are affixed each other.
